(19) United States
(12) Patent Application Publication
(10) Pub. No.: US 2012/0301211 A1
(43) Pub. Date: Nov. 29, 2012

(54) Two-way moving structure of a paper folder

(76) Inventor: Chun Yuan Chang, Taipei (TW)

(21) Appl. No.: 13/116,019

(22) Filed: May 26, 2011

(51) Int. Cl. B42F 13/14

(52) U.S. Cl. 402/60

(57) ABSTRACT

A two-way moving structure of the paper folder contains a bottom plate, each including two grooves formed on two sides thereof respectively; two retaining members, each including an insertion and an abutting portion connecting with the insertion, the abutting portion including a receiving area formed on a bottom end thereof and an fastening rib fixed on an inner side of the receiving area; wherein the insertion of the retaining member is inserted into the groove of the bottom plate; two movable member, each including a side slab and at least one post extending outward from an inner side of the side slab, wherein the side slab includes a lock shaft, and the lock shaft of the movable member is placed in the receiving area of the retaining member and is abutted against by the fastening rib, and the two posts of the movable member are connected together.

### BACKGROUND OF THE INVENTION

1. Field of the Invention

The present invention relates to a two-way moving structure of a paper folder.

2. Description of the Prior Art

A conventional paper folder is used to place papers, but when removing a desired paper from the paper folder, all papers have to be removed first, and then a user has spends some times finding the desired paper to further take the paper, having a time-consuming operation.

To improve such a problem, an improved two-way moving structure of a paper folder has been developed, but it is complicated that has to be produced at a high cost.

The present invention has arisen to mitigate and/or obviate the afore-described disadvantages.

### SUMMARY OF THE INVENTION

The primary object of the present invention is to provide a two-way moving structure of a paper folder that is capable of being operated easily.

Another object of the present invention is to provide a two-way moving structure of a paper folder that is produced at a lower cost.

To obtain the above objective, two-way moving structure of a paper folder provided by the present invention contains:

a bottom plate, each including two grooves formed on two sides thereof respectively;

two retaining members, each including an insertion and an abutting portion connecting with the insertion, the abutting portion including a receiving area formed on a bottom end thereof and an fastening rib fixed on a top rim of an inner side of the receiving area; wherein the insertion of the retaining member is inserted into the groove of the bottom plate;

two movable member, each including a side slab and at least one post extending outward from an inner side of the side slab, wherein the side slab includes a lock shaft, and the lock shaft of the movable member is placed in the receiving area of the retaining member and is abutted against by the fastening rib, and the two posts of the movable member are connected together.

### BRIEF DESCRIPTION OF THE DRAWINGS

FIG. 1 is a perspective view showing the exploded components of a two-way moving structure of a paper folder according to a preferred embodiment of the present invention;

FIG. 2 is a perspective view showing the assembly of the two-way moving structure of the paper folder according to the preferred embodiment of the present invention;

FIG. 3 is a perspective view showing the application of the two-way moving structure of the paper folder according to the preferred embodiment of the present invention;

FIG. 4 is a cross-sectional perspective view showing the application of the two-way moving structure of the paper folder according to the preferred embodiment of the present invention;

FIG. 5 is a cross-sectional view showing the operation of the two-way moving structure of the paper folder according to the preferred embodiment of the present invention;

FIG. 6 is also cross-sectional view showing the operation of the two-way moving structure of the paper folder according to the preferred embodiment of the present invention;

FIG. 7 is another cross-sectional view showing the operation of the two-way moving structure of the paper folder according to the preferred embodiment of the present invention;

FIG. 8 is another perspective view showing the application of the two-way moving structure of the paper folder according to the preferred embodiment of the present invention;

FIG. 9 is a cross sectional view showing the application of the two-way moving structure of the paper folder according to the preferred embodiment of the present invention;

FIG. 10 is a perspective view showing the application of the two-way moving structure of the paper folder according to the preferred embodiment of the present invention;

FIG. 11 is another perspective view showing the application of the two-way moving structure of the paper folder according to the preferred embodiment of the present invention;

FIG. 12 is also a perspective view showing the application of the two-way moving structure of the paper folder according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

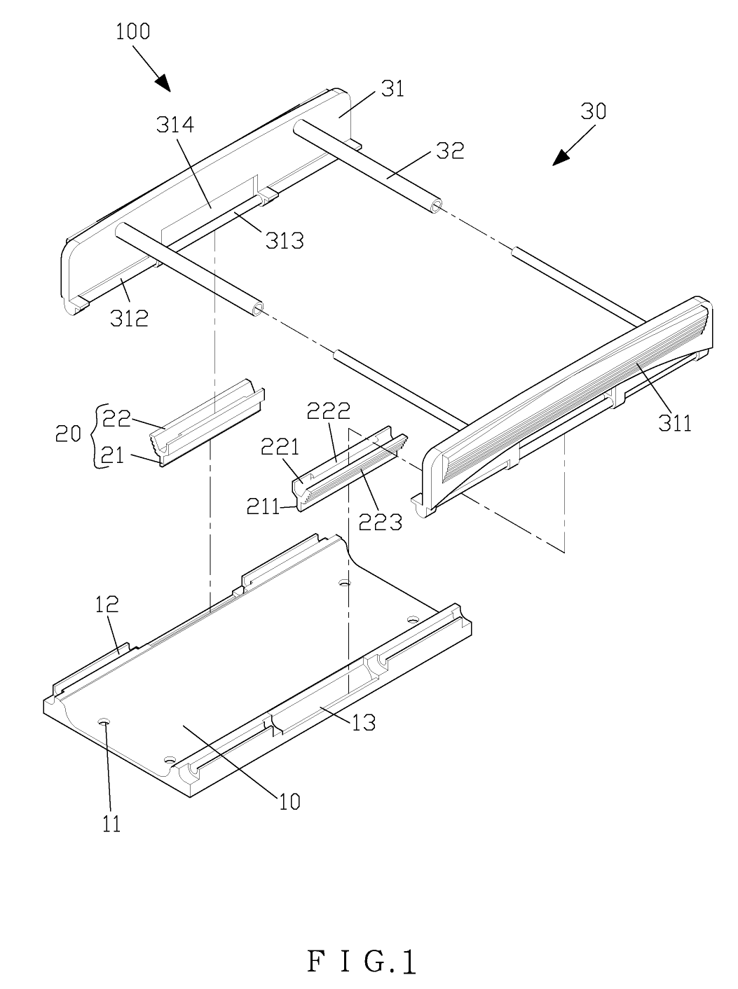

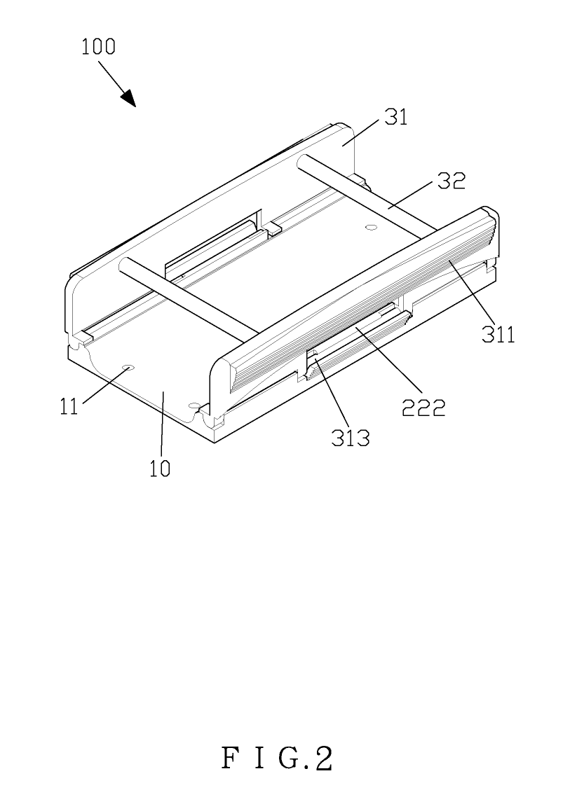

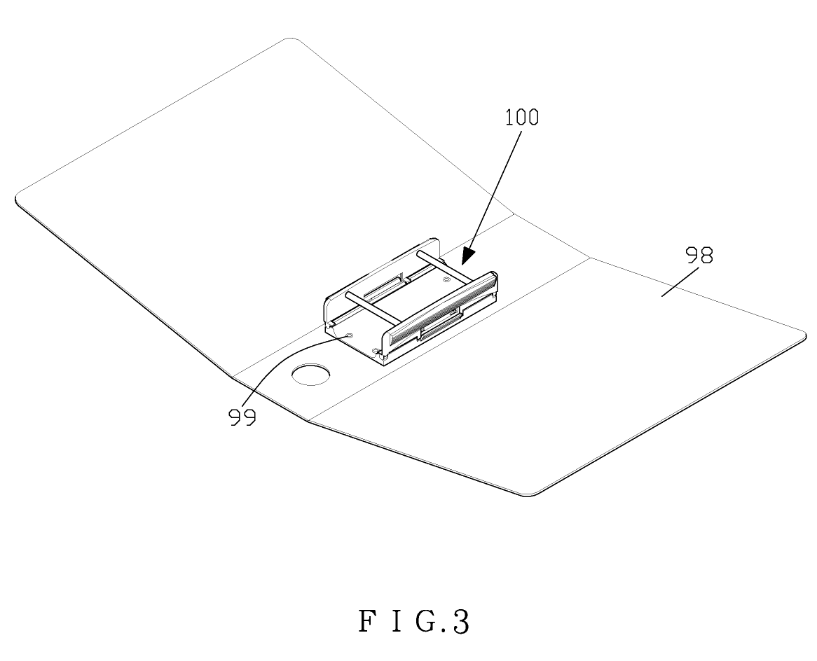

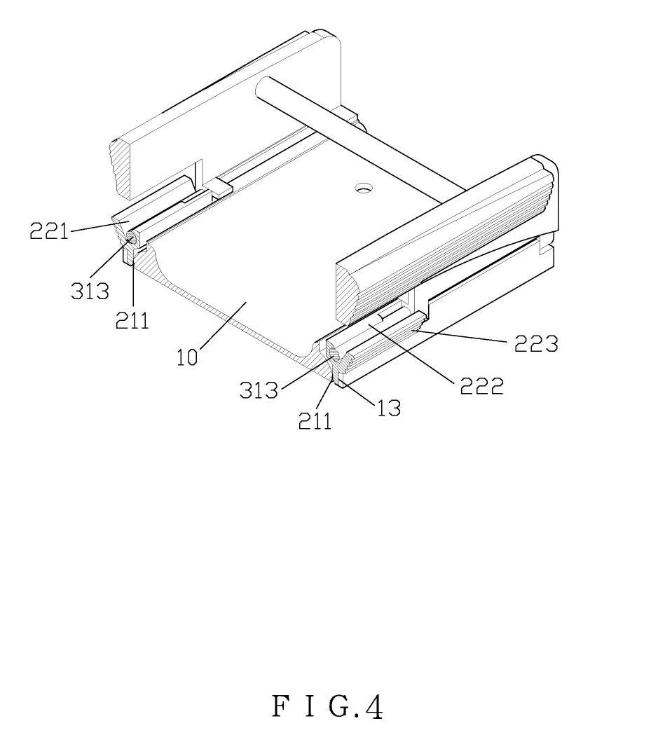

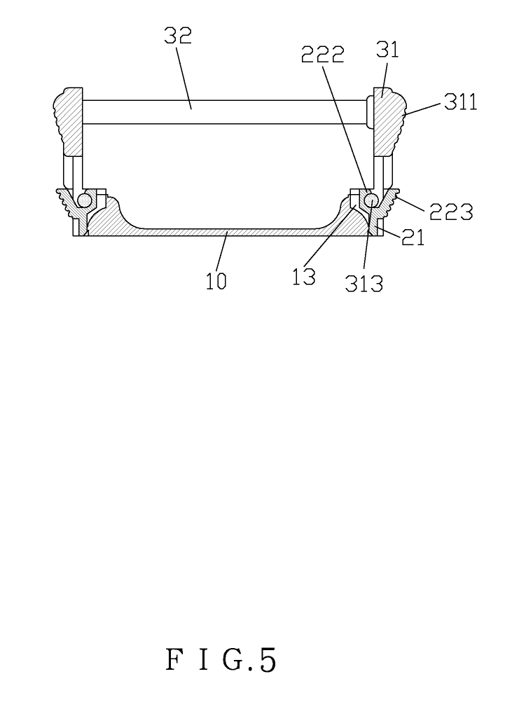

Referring to FIGS. 1-12, a two-way moving structure of a paper folder in accordance with a first embodiment of the present invention comprises a bottom plate 10, two retaining members 20, and two movable members 30.

As shown in FIGS. 1-3, the bottom plate 10 includes a plurality of holes 11 to insert a number of locking members 99 respectively so that the locking members 99 are fixed on an inner surface of a panel 98, four slots 12 disposed on four corners thereof individually, and two grooves 13 defined between each two slots 12 of two sides of the bottom plate 10, wherein the locking member 99 is a rivet.

With reference to FIGS. 1, 2, and 4, the retaining member 20 includes an insertion 21 and an abutting portion 22 connecting with the insertion 21, and the insertion 21 includes a hooking portion 211 extending from a bottom end thereof, the abutting portion 22 includes a receiving area 221 formed on a bottom end thereof, an fastening rib 222 fixed on a top rim of an inner side of the receiving area 221, and an anti-slip portion 223 arranged on an outer surface thereof and comprised of a plurality of first raised straps; wherein the insertion 21 of the retaining member 20 is inserted into the groove 13 of the bottom plate 10 and retained in groove 13 by using the hooking portion 211 of the retaining member 20 to prevent the hooking portion 211 of the retaining member 20 from disengaging from the bottom plate 10, and the anti-slip portion 223 of the retaining member 20 faces outward.

As illustrated in FIGS. 1, 2, 4, and 5, the movable member 30 includes a side slab 31 and two posts 32 extending outward from an inner side of the side slab 31, and a predetermined distance is defined between the two posts 32, the side slab 31 includes a skidproof zone 311 fixed on an outer surface thereof, wherein the skidproof zone 311 is comprised of a plurality of second raised straps, and the side slab 31 also includes two rotary shafts 312 between which a lock shaft 313 is defined, the lock shaft 313 includes a hollow area 314; hence the rotary shaft 312 of the movable member 30 is axially connected with the slot 12 of the bottom plate 10, and the lock shaft 313 of the movable member 30 is placed in the receiving area 221 of the retaining member 20 and is inserted into the hollow area 314 from the fastening rib 222 to abut against the lock shaft 313 so that when the retaining member 20 is acted by an external force, the movable member 30 is acted by the external force as well to rotate axially along the lock shaft 313 and the receiving area 221, and the skidproof zone 311 faces outward, the two hosts 32 of the movable member 30 are connected together.

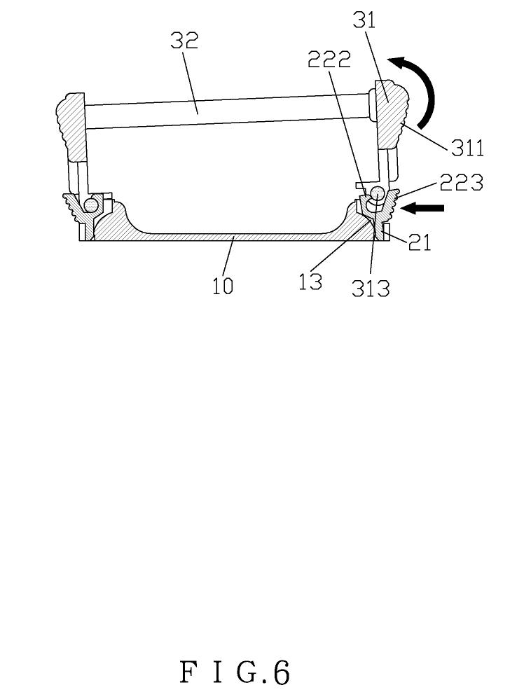

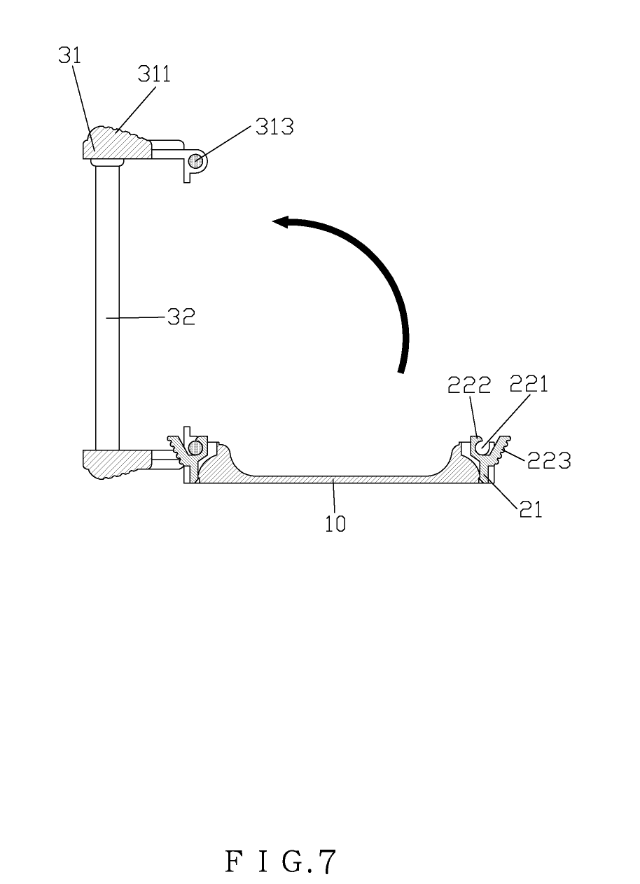

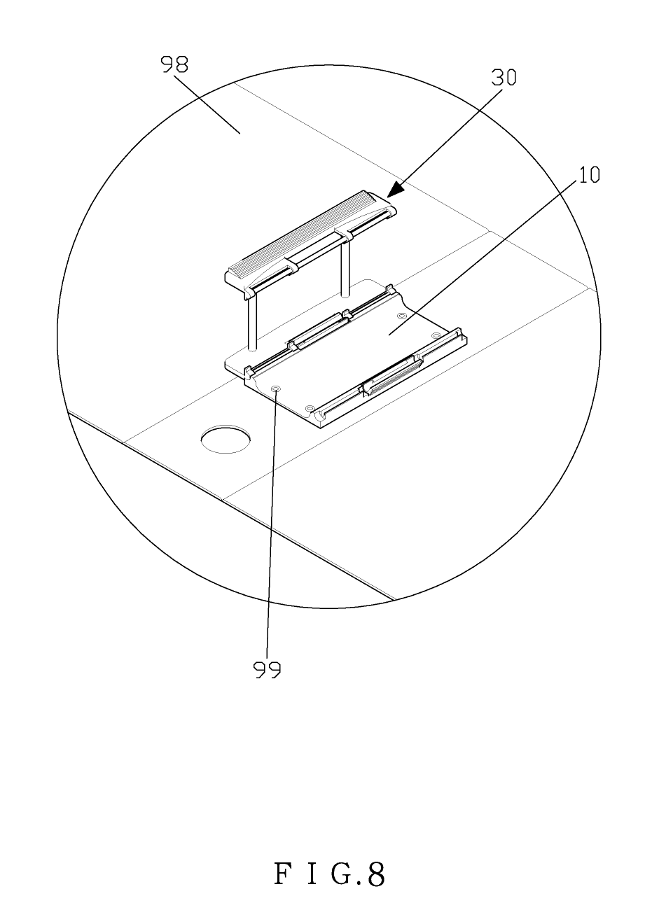

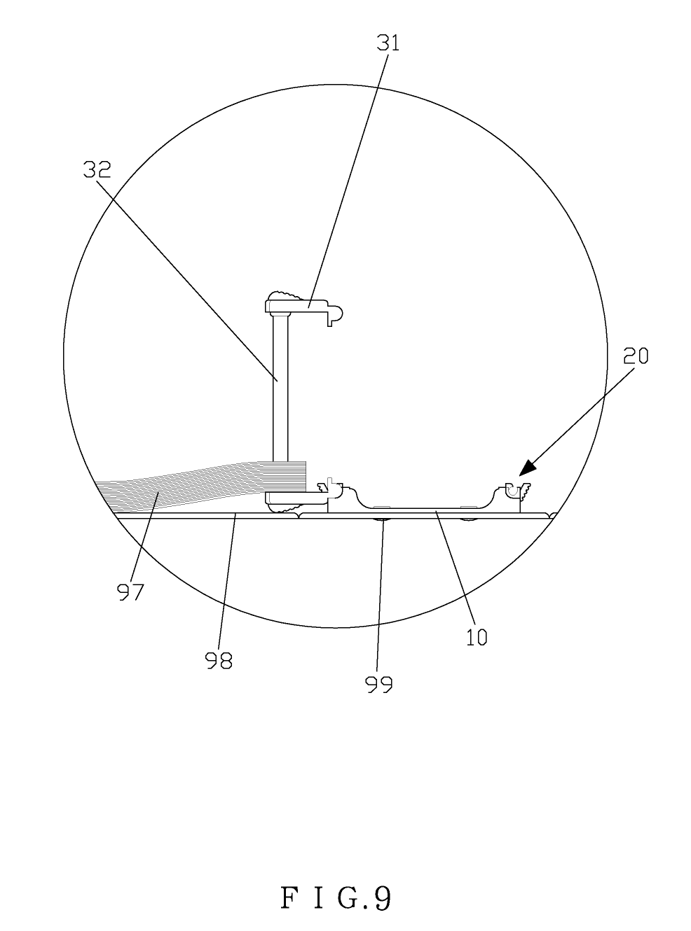

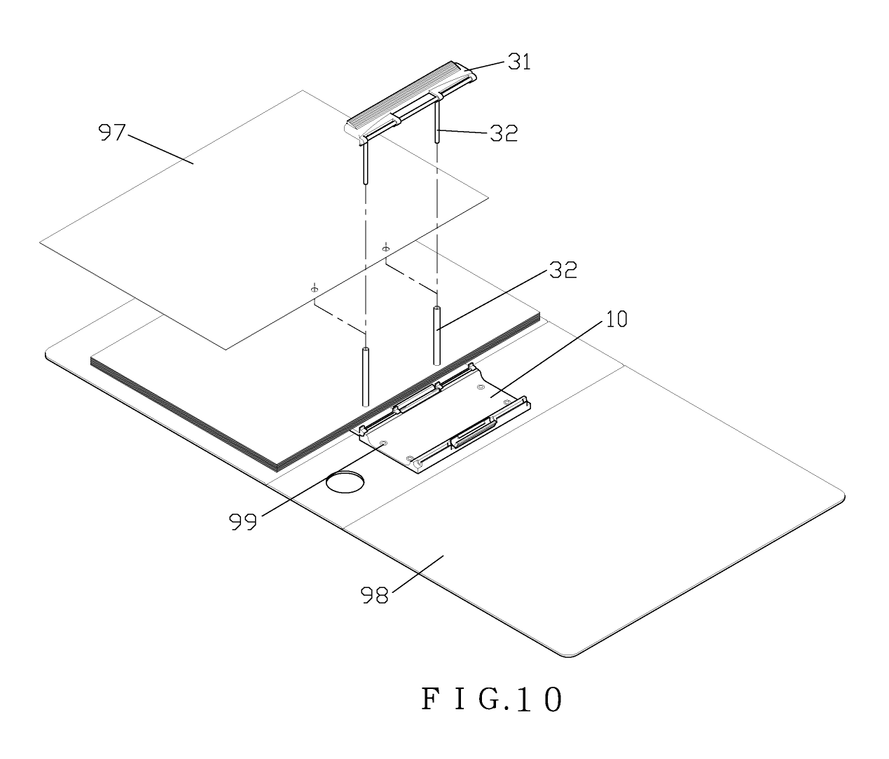

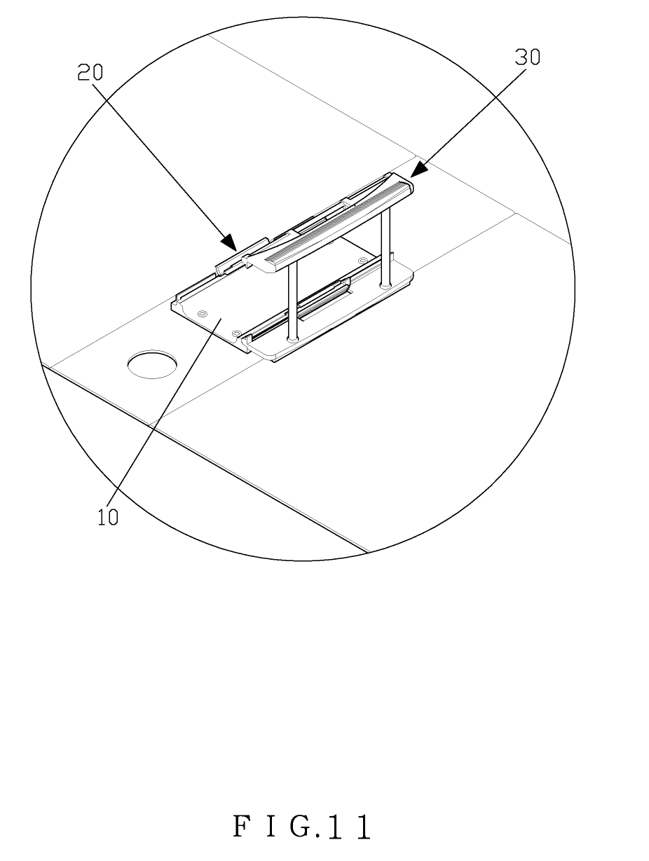

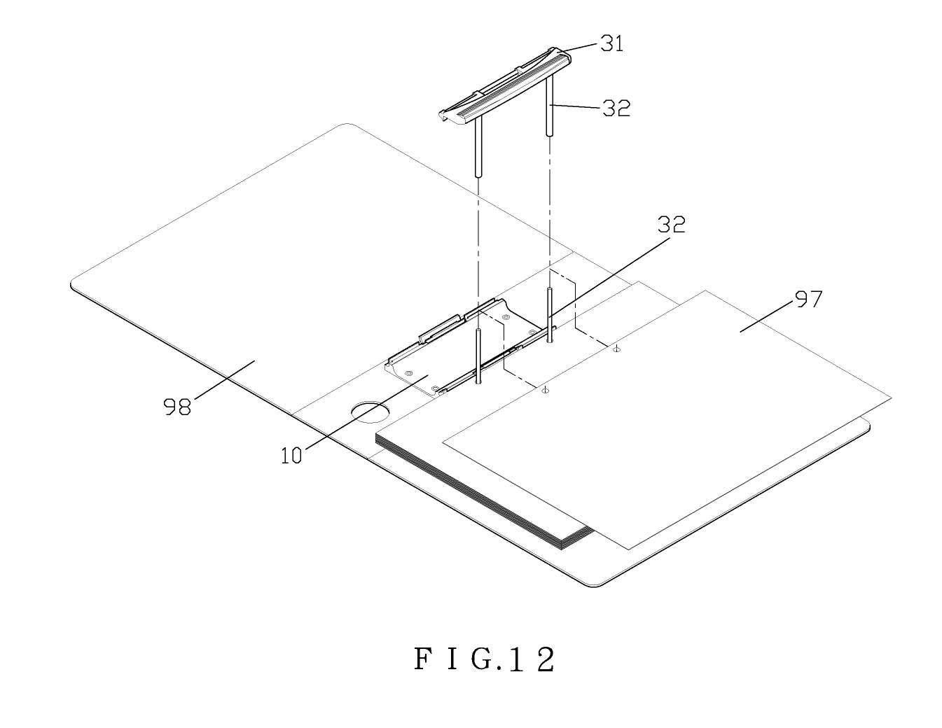

Thereby, when a paper is placed in the paper folder, a user is capable of pressing any one of the anti-slip portions 223 of the retaining members 20, i.e., the retaining member 20 is forced inward so as to swing inward, and the fastening rib 222 disengages from the hollow area 314 of the movable member 30 to further disengage from the lock shaft 313 (as shown in FIG. 6), hence the movable member 30 which disengages from the retaining members 20 is turned (as illustrated in FIGS. 7 and 8), thereafter the post 32 of the movable member 30 disengages from that of another movable member 30 so that the paper 97 is fixed on (as shown in FIG. 9) or removed from (as shown in FIG. 10) the post 32 of the movable member 30. Of course, as desiring to position the paper from another movable member 30, another retaining member 20 is pressed, and then the movable member 30 relative to the another movable member 30 is turned (as shown in FIGS. 11 and 12).

In addition, a number of the post 32 of the movable member 30 is capable of being changed based on a number of drilled orifices of the paper.

While we have shown and described various embodiments in accordance with the present invention, it is clear to those skilled in the art that further embodiments may be made without departing from the scope of the present invention.

What is claimed is:

1. A two-way moving structure of a paper folder comprising:
a bottom plate, each including two grooves formed on two sides thereof respectively;
two retaining members, each including an insertion and an abutting portion connecting with the insertion, the abutting portion including a receiving area formed on a bottom end thereof and an fastening rib fixed on a top rim of an inner side of the receiving area; wherein the insertion of the retaining member is inserted into the groove of the bottom plate;
two movable member, each including a side slab and at least one post extending outward from an inner side of the side slab, wherein the side slab includes a lock shaft, and the lock shaft of the movable member is placed in the receiving area of the retaining member and is abutted against by the fastening rib, and the two posts of the movable member are connected together.

2. The two-way moving structure of a paper folder as claimed in claim 1, wherein the bottom plate includes a plurality of holes to insert a number of locking members respectively so that the locking members are fixed on an inner surface of a panel.

3. The two-way moving structure of a paper folder as claimed in claim 1, wherein the bottom plate includes four slots disposed on four corners thereof individually; the movable member also includes two rotary shafts fixed in the slots of the bottom plate.

4. The angle adjusting stand as claimed in claim 3, the two grooves of the bottom plate are defined between each two slots of two sides of the bottom plate, and the lock shaft is defined between two rotary shafts.

5. The angle adjusting stand as claimed in claim 1, wherein the insertion includes a hooking portion to retain the insertion of the retaining member in the groove.

6. The angle adjusting stand as claimed in claim 1, wherein the abutting portion includes an anti-slip portion arranged on an outer surface thereof and comprised of a plurality of first raised straps, and the side slab includes a skidproof zone fixed on an outer surface thereof, wherein the skidproof zone is comprised of a plurality of second raised straps.

7. The angle adjusting stand as claimed in claim 1, wherein the lock shaft of the movable member includes a hollow area so that the fastening rib of the retaining member is inserted into the hollow area and abuts against the lock shaft.
